(19) United States
(12) Patent Application Publication
(10) Pub. No.: US 2020/0189618 A1
(43) Pub. Date: Jun. 18, 2020

(54) VEHICLE AND CONTROL DEVICE AND CONTROL METHOD OF THE VEHICLE

(71) Applicant: HONDA MOTOR CO., LTD., Tokyo (JP)

(72) Inventors: Jun Ochida, Wako-shi (JP); Mahito Shikama, Wako-shi (JP); Tadahiko Kanoh, Wako-shi (JP)

(21) Appl. No.: 16/803,080

(22) Filed: Feb. 27, 2020

Related U.S. Application Data
(63) Continuation of application No. PCT/JP2017/032291, filed on Sep. 7, 2017.

(51) Int. Cl. B60W 60/00; B60W 50/035; B60W 50/14; G05D 1/00

(52) U.S. Cl. CPC B60W 60/0053; B60W 50/035; B60W 50/14; B60W 2552/05; G05D 1/0088; B60W 2720/106; B60W 2554/40; G05D 1/0061

(57) ABSTRACT

A control device that performs travel control of a vehicle includes a sensor that detects a situation around the vehicle, and a travel control unit that performs travel control for automated driving based on a detection result of the sensor. During execution of stop transition control of decelerating or stopping the vehicle, the travel control unit causes the vehicle to stay on a traveling road when the detection result of the sensor or a state of the vehicle satisfies a predetermined condition, and moves the vehicle to an off-road area adjacent to the traveling road when the detection result of the sensor or the state of the vehicle does not satisfy the predetermined condition.

### CROSS-REFERENCE TO RELATED APPLICATION(S)

This application is a continuation of International Patent Application No. PCT/JP2017/032291 filed on Sep. 7, 2017, the entire disclosures of which is incorporated herein by reference.

### BACKGROUND OF THE INVENTION

### Field of the Invention

The present invention relates to a vehicle, and a control device and a control method of the vehicle.

### Description of the Related Art

Japanese Patent Laid-Open No. 9-161196 describes a control device that controls switching between automated driving and manual driving of a vehicle. The control device detects that the vehicle approaches a scheduled point to switch from automated driving to manual driving, and when the control device determines that switching to the manual driving is not completed before the vehicle reaches the scheduled point, the control device forcefully decelerates the vehicle and stops the vehicle on a roadside strip.

### SUMMARY OF THE INVENTION

Stopping a vehicle on a roadside strip reduces an influence on other vehicles on traffic. However, stopping on the roadside strip is not always the best. One aspect of the present invention provides a technique for determining a favorable position of a vehicle when decelerating or stopping the vehicle.

According to one embodiment, there is provided a control device that performs travel control of a vehicle, the control device comprising: a sensor that detects a situation around the vehicle; and a travel control unit that performs travel control for automated driving based on a detection result of the sensor, wherein during execution of stop transition control of decelerating or stopping the vehicle, the travel control unit causes the vehicle to stay on a traveling road when the detection result of the sensor or a state of the vehicle satisfies a predetermined condition, and moves the vehicle to an off-road area adjacent to the traveling road when the detection result of the sensor or the state of the vehicle does not satisfy the predetermined condition.

Other features and advantages of the present invention will be apparent from the following description taken in conjunction with the accompanying drawings. Note that the same reference numerals denote the same or like components throughout the accompanying drawings.

### BRIEF DESCRIPTION OF THE DRAWINGS

The accompanying drawings are included in the specification, configure a part of the specification, show embodiments of the present invention, and are used for explaining the principle of the present invention with the description.

FIG. 1 is a block diagram of a vehicle according to an embodiment.

FIG. 2A and FIG. 2B are flowcharts realizing a process example executed in a control device of the embodiment.

FIG. 3A is a schematic view explaining a stop position of the vehicle of the embodiment.

FIG. 3B is a schematic view explaining a stop position of the vehicle of the embodiment.

### DESCRIPTION OF THE EMBODIMENTS

Embodiments of the present invention will be described with reference to the accompanying drawings. Same elements are assigned with same reference signs throughout various embodiments, and redundant explanation will be omitted. Further, various embodiments can be properly changed and combined.

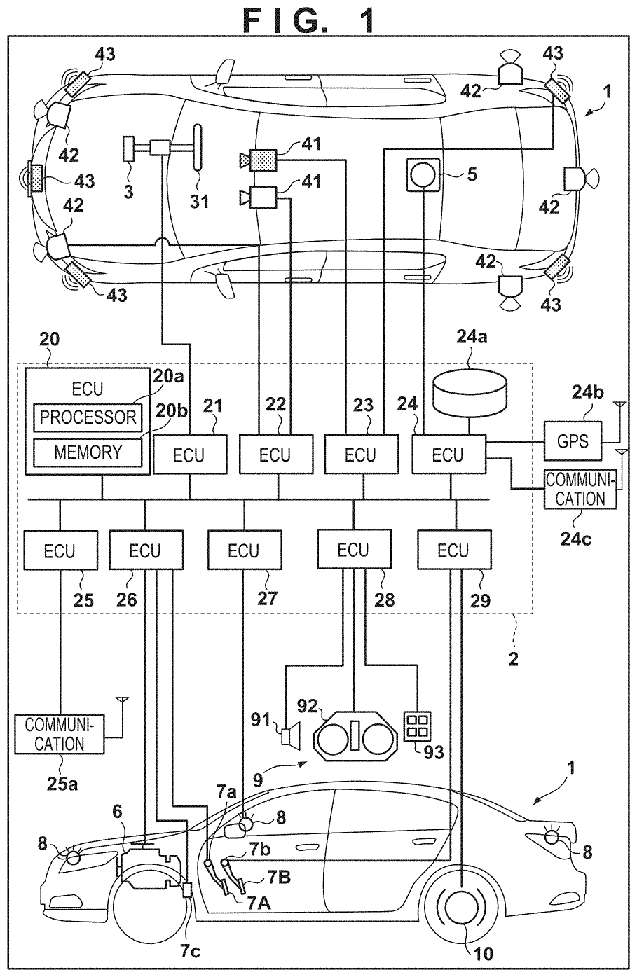

FIG. 1 is a block diagram of a vehicle control device according to one embodiment of the present invention, which controls a vehicle 1. In FIG. 1, an outline of the vehicle 1 is illustrated in a plan view and a side view. The vehicle 1 is a sedan-type four-wheeled passenger car, as an example.

The control device in FIG. 1 includes a control unit 2. The control unit 2 includes a plurality of ECUs 20 to 29 that are communicably connected by an in-vehicle network. Each of the ECUs includes a processor represented by a CPU, a memory such as a semiconductor memory, an interface with an external device, and the like. In the memory, programs executed by the processor, data and the like used in processing by the processor are stored. Each of the ECUs may include a plurality of processors, a plurality of memories, a plurality of interfaces and the like. For example, an ECU 20 includes a processor 20a and a memory 20b. The processor 20a executes a command included by a program stored in the memory 20b, and thereby a process by the ECU 20 is executed. Instead of the processor 20a, the ECU 20 may include an exclusive integrated circuit such as ASIC for executing the process by the ECU 20.

Hereinafter, functions and the like assigned to the respective ECUs 20 to 29 will be described. Note that the number of ECUs, and functions assigned to the ECUs can be properly designed, and can be more fragmented or integrated than the present embodiment.

The ECU 20 executes control relating to automated driving of the vehicle 1. In the automated driving, at least one of steering of the vehicle 1, and/or acceleration and deceleration is automatically controlled. In a control example described later, both of steering, and acceleration and deceleration are automatically controlled.

The ECU 21 controls an electric power steering device 3. The electric power steering device 3 includes a mechanism that steers front wheels in response to a driving operation (steering operation) of a driver to a steering wheel 31. Further, the electric power steering device 3 includes a motor that provides a driving force to assist a steering operation, and automatically steer the front wheels, a sensor that detects a steering angle, and the like. When a driving state of the vehicle 1 is automated driving, the ECU 21 automatically controls the electric power steering device 3 in response to an instruction from the ECU 20, and controls a traveling direction of the vehicle 1.

ECUs 22 and 23 perform control of detection units 41 to 43 that detect a situation around the vehicle, and information processing of detection results. The detection unit 41 is a camera that captures a front of the vehicle 1 (Hereinafter, may be described as a camera 41.), and in the case of the present embodiment, two cameras 41 are provided at a roof front portion of the vehicle 1. By analyzing an image captured by the camera 41, it is possible to extract an outline of a target, and lane division lines (white line and the like) on a road.

A detection unit 42 is a LIDAR (Light Detection and Ranging) (hereinafter, may be described as a LIDAR 42), and detects a target around the vehicle 1 and measures a distance from the target. In the case of the present embodiment, five LIDARs 42 are provided, one at each corner of a front of the vehicle 1, one at a center of a rear, and one on each side of the rear. The detection unit 43 is a millimeter wave radar (hereinafter, may be described as a radar 43), detects a target around the vehicle 1, and measures a distance from the target. In the case of the present embodiment, five radars 43 are provided, one at a center of the front of the vehicle 1, one at each corner of the front, and one at each corner of the rear.

The ECU 22 controls one of the cameras 41 and respective LIDARs 42, and performs information processing of detection results. The ECU 23 controls the other camera 41 and the respective radars 43, and performs information processing of detection results. Two pairs of devices that detect the situation around the vehicle are included, and thereby reliability of the detection result can be increased, and different kinds of detection units such as the cameras, LIDARS and radars are included, and thereby analysis of an environment around the vehicle can be performed from many different angles.

An ECU 24 controls a gyro sensor 5, a GPS sensor 24b and a communication device 24c and performs information processing of detection results or a communication result. The gyro sensor 5 detects a rotational movement of the vehicle 1. A course of the vehicle 1 can be determined by a detection result of the gyro sensor 5, a wheel speed and the like. The GPS sensor 24b detects a current position of the vehicle 1. The communication device 24c wirelessly communicates with a server that provides map information and traffic information, and acquires the map information and traffic information. The ECU 24 is accessible to a database 24a of map information constructed in the memory, and performs a route search from a current location to a destination, and the like. The ECU 24, the map database 24a and the GPS sensor 24b construct a so-called navigation device.

An ECU 25 includes a communication device 25a for vehicle-to-vehicle communication. The communication device 25a performs wireless communication with other surrounding vehicles, and exchanges information among the vehicles.

An ECU 26 controls a power plant 6. The power plant 6 is a mechanism that outputs a drive force to rotate drive wheels of the vehicle 1, and includes an engine and a transmission, for example. The ECU 26 controls an output of the engine in response to a driving operation (an accelerator operation or an acceleration operation) of a driver which is detected by an operation detection sensor 7a provided at an accelerator pedal 7A, and switches a gear ratio of the transmission based on information on a vehicle speed or the like detected by a vehicle speed sensor 7c, for example. When a driving state of the vehicle 1 is automated driving, the ECU 26 automatically controls the power plant 6 in response to an instruction from the ECU 20, and controls acceleration and deceleration of the vehicle 1.

An ECU 27 controls lamps (headlight, tail light and the like) including a direction indicator 8 (blinker). In the case of an example in FIG. 1, the direction indicator 8 is provided at the front, door mirrors and a rear of the vehicle 1.

An ECU 28 controls an input and output device 9. The input and output device 9 outputs information to the driver, and receives input of information from the driver. An audio output device 91 notifies the driver of information by sound. A display device 92 notifies the driver of information by display of an image. The display device 92 is disposed in front of a driver's seat, for example, and configures an instrument panel or the like. Note that sound and display are illustrated here, but information may be notified by vibration and light. Further, information may be notified by combining two or more of sound, display, vibration and light. Furthermore, depending on a level of information to be notified (degree of urgency, for example), different combinations, and different notification modes may be used. The input device 93 is a group of switches disposed at a position operable by the driver and for giving an instruction to the vehicle 1, and may include an audio input device.

The ECU 29 controls a brake device 10 and a parking brake (not illustrated). The brake device 10 is, for example, a disc brake device, is provided at each of the wheels of the vehicle 1, and decelerates or stops the vehicle by adding resistance to rotation of the wheel. The ECU 29 controls an operation of the brake device 10 in response to a driving operation (brake operation) of the driver that is detected by an operation detection sensor 7b provided at a brake pedal 7B, for example. When the driving state of the vehicle 1 is automated driving, the ECU 29 automatically controls the brake device 10 in response to an instruction from the ECU 20, and controls deceleration and stop of the vehicle 1. The brake device 10 and a parking brake can also be operated to keep a stopping state of the vehicle 1. Further, when the transmission of the power plant 6 includes a parking lock mechanism, the parking lock mechanism can also be operated to keep the stopping state of the vehicle 1.

### Control Example

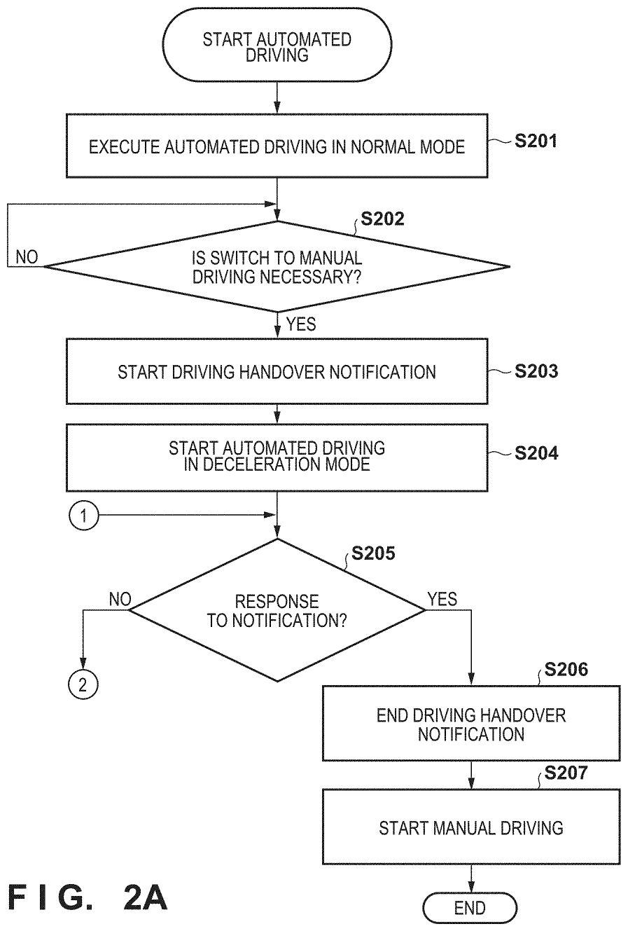

Referring to FIG. 2A and FIG. 2B, a control example of the vehicle 1 by the ECU 20 will be described. Flowcharts in FIG. 2A and FIG. 2B are started when the driver of the vehicle 1 gives an instruction to start automated driving, for example. The ECU 20 functions as the control device of the vehicle 1. Specifically, in the following operation, the ECU 20 functions as a travel control unit that performs travel control for automated driving based on a detection result of the sensors (for example, the detection units 41 to 43, a wheel speed sensor, a yaw rate sensor, a G sensor and the like) that detect a situation around the vehicle 1.

In step S201, the ECU 20 executes automated driving in a normal mode. The normal mode refers to a mode in which all of steering, driving and braking are executed as necessary to reach the destination.

In step S202, the ECU 20 determines whether switching to manual driving is necessary. The ECU 20 advances the process to step S203 when switching is necessary (“YES” in S202), and repeats step S202 when switching is not necessary (“NO” in step S202). The ECU 20 determines that switching to the manual driving is necessary, when it is determined that some of the functions of the vehicle 1 are reduced, when it is difficult to continue automated driving due to a change in a surrounding traffic state, and when the vehicle 1 reaches a vicinity of the destination set by the driver.

In step S203, the ECU 20 starts driving handover notification. The driving handover notification is notification for requesting the driver to switch to manual driving. Operations in following steps S204, S205, and S208 to S213 are performed during execution of driving handover notification.

In step S204, the ECU 20 starts automated driving in a deceleration mode. The deceleration mode is a mode in which steering and braking are executed as necessary and a response to driving handover notification of the driver is awaited. In the deceleration mode, the vehicle 1 may be naturally decelerated by engine brake or regenerative brake, or braking (for example, friction brake) using a braking actuator may be performed. Further, even when the vehicle is naturally decelerated, the ECU 20 may increase strength of deceleration regeneration (by increasing a regeneration amount, for example), or strength of the engine brake may be increased (by reducing a gear ratio, for example).

In step S205, the ECU 20 determines whether the driver responds to the driving handover notification. The ECU 20 advances the process to step S206 when the driver responds (“YES” in S205), or advances the process to step S208 when the driver does not respond (“NO” in step S205). The driver can use the input device 93, for example, to indicate intention to shift to manual driving. Instead of the input device 93, the driver may indicate intention of consent using steering detected by a steering torque sensor.

In step S206, the ECU 20 ends driving handover notification. In step S207, the ECU 20 ends automated driving in the deceleration mode under execution and starts manual driving. In the manual driving, the respective ECUs of the vehicle 1 control travel of the vehicle 1 according to the driving operation of the driver. The ECU 28 may output a message or the like that prompts the driver to bring the vehicle 1 to a garage to the display device 92, because the ECU 20 may have performance degradation or the like.

In step S208, the ECU 20 determines whether a predetermined time period (for example, a time period corresponding to an automated driving level of the vehicle 1 such as four seconds, 15 seconds or the like) elapses after start of driving handover notification. The ECU 20 advances the process to step S209 when the predetermined time period elapses (“YES” in S208), or returns the process to step S205 to repeat the processes of step S205 and the following steps, when the predetermined time period does not elapse (“NO” in step S208).

In step S209, the ECU 20 ends automated driving in a deceleration mode under execution and starts automated driving in a stop transition mode. The stop transition mode is a mode for stopping the vehicle 1 in a safe position or decelerating the vehicle 1 to a lower speed than a deceleration end speed in the deceleration mode. Specifically, the ECU 20 searches for a position where the vehicle 1 is stoppable while actively decelerating the vehicle 1 to the speed lower than the deceleration end speed in the deceleration mode. When the ECU 20 can find the stoppable position, the ECU 20 stops the vehicle 1 in the stoppable position, or when the ECU 20 cannot find the stoppable position, the ECU 20 searches for a stoppable position while causing the vehicle 1 to travel at an extremely low speed (a creep speed, for example). Operations in following steps S210 to S213 are performed during execution of the stop transition mode.

In step S210, the ECU 20 determines whether the detection result of the sensors of the vehicle 1 or the state of the vehicle 1 satisfies a predetermined condition. When the predetermined condition is satisfied (“YES” in S210), the ECU 20 advances the process to step S212, or when the predetermined condition is not satisfied (“NO” in step S210), the ECU 20 advances the process to step S211. The sensors mentioned here are sensors that are used in automated driving, and may include the detection units 41 to 43, for example.

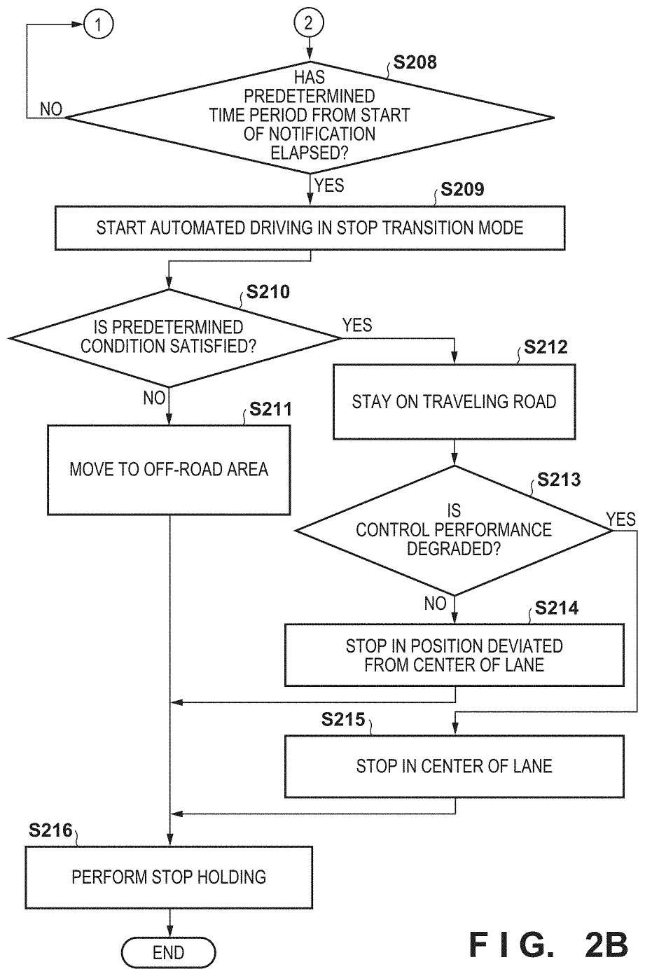

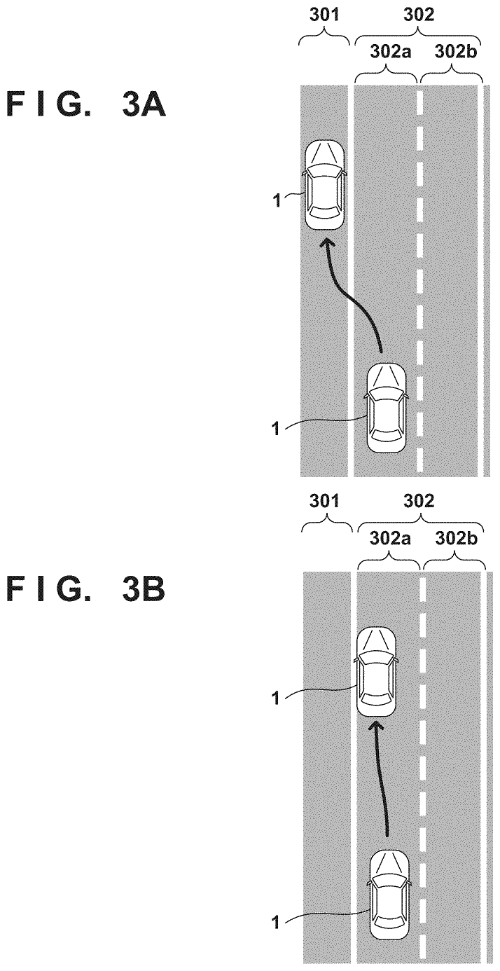

Referring to FIGS. 3A and 3B, the predetermined condition in step S210 will be described. In explanation in FIGS. 3A and 3B, the vehicle 1 is assumed to be traveling on a left-hand road. The road on which the vehicle 1 is traveling is configured by a traveling road 302 and an off-road area 301 (a roadside strip or a road shoulder, for example) adjacent to the traveling road 302. In examples in FIGS. 3A and 3B, the traveling road 302 is divided into two lanes 302a and 302b.

In step S211, the ECU 20 moves the vehicle 1 to the off-road area 301 in a period before stopping the vehicle 1, as illustrated in FIG. 3A. In step S212, the ECU 20 keeps the vehicle 1 on the traveling road 302 until the ECU 20 stops the vehicle 1, as illustrated in FIG. 3B. The ECU 20 may change the lane in the traveling road 302 as necessary.

As illustrated in FIG. 3A, when the vehicle 1 is stopped, moving the vehicle 1 to the off-road area 301 can prevent interference with traffic of other vehicles. However, when the detection result of the sensors of the vehicle 1 or the state of the vehicle 1 satisfies the predetermined condition, it may be difficult to move the vehicle 1 to the off-road area 301.

For example, when the off-road area 301 cannot be detected as the detection result of the sensors of the vehicle 1, the ECU 20 cannot move the vehicle 1 safely to the off-road area 301. The case where the off-road area 301 cannot be detected includes a case where the off-road area 301 does not exist, and a case where the off-road area 301 exists, but the sensors cannot normally detect the off-road area 301. The case where the sensors cannot normally detect the off-road area 301 includes, for example, a failure of the sensors, and performance degradation of the sensors. The failure of the sensors includes a change in sensor mounting angle, and a failure of insides of the sensors. Performance degradation of the sensor includes degradation due to worsening of the environment between the sensors and an object due to external factors such as weather, and degradation due to fogging of lenses and covering of the sensors.

Further, the ECU 20 cannot move the vehicle 1 safely to the off-road area 301 when the off-road area 301 can be detected, but presence of an obstacle in the off-road area 301 is detected. Further, by causing the vehicle 1 to stay on the traveling road 302 when control performance of the vehicle 1 is degraded, a risk caused by moving the vehicle 1 to the off-road area 301 is reduced. In this way, the predetermined condition in step S210 may include at least one of the fact that the off-road area adjacent to the traveling road cannot be detected, the fact that an obstacle is detected in the off-road area adjacent to the traveling road, and/or the fact that the control performance of the vehicle 1 is degraded. In the aforementioned example, the ECU 20 detects the presence of the off-road area by the sensor, but may determine that the off-road area (road shoulder) exists by a map or the like.

In step S213, the ECU 20 determines whether the control performance of the vehicle 1 is degraded. When the control performance of the vehicle 1 is not degraded (“NO” in S213), the ECU 20 advances the process to step S214, or when the control performance of the vehicle 1 is degraded (“YES” in S213), the ECU 20 advances the process to step S215. The ECU 20 determines that the control performance of the vehicle 1 is degraded when function of at least any one of the ECU 20, the ECU 21, a drive actuator, the braking actuator and/or a steering actuator is degraded, and may determine that the control performance of the vehicle 1 is not degraded when functions of other mechanisms than the above are degraded.

In step S214, the ECU 20 stops the vehicle 1 in a position deviated from a center of the lane of the traveling road 302, as illustrated in FIG. 3B. A state where the vehicle 1 is stopping in the position deviated from the center of the lane is a state where the center of the lane and a center line of the vehicle 1 are not superimposed on each other, for example. The center of the lane indicates a portion on which a center line of the vehicle is superimposed during normal traveling, for example. In step S215, the ECU 20 stops the vehicle 1 in the center of the lane of the traveling road 302. By stopping the vehicle 1 in the center of the lane, a risk caused by moving the vehicle 1 in the position deviated from the center is reduced.

In step S216, the ECU 20 determines stoppage of the vehicle 1 from a detection result of the engine speed sensor, and when the ECU 20 determines that the vehicle 1 stops, the ECU 20 instructs the ECU 29 to actuate the electric parking lock device and performs stop holding control of keeping stoppage of the vehicle 1. When automated driving in the stop transition mode is performed, it may be notified to other surrounding vehicles that the stop transition is performed, by a hazard lamp, or other display devices, or it may be notified to other vehicles and other terminal devices, by the communication device. During execution of automated driving in the stop transition mode, the ECU 20 may perform deceleration control depending on presence or absence of a following vehicle. For example, the ECU 20 may increase a degree of deceleration more when there is no following vehicle than a degree of deceleration in a case where the following vehicle is present.

In the above described embodiment, as the automated driving control executed by the ECU 20 in the automated driving mode, the automated driving control to automate all of driving, braking and steering is described, but automated driving control can control at least one of driving, braking and/or steering without depending on the driving operation of the driver. To control without depending on the driving operation of the driver includes to control without input by the driver to the controllers represented by a steering wheel, and a pedal, or can be said that the intention of the driver to drive the vehicle is not essential. Accordingly, automated driving control may be in a state in which the driver is obliged to monitor the surroundings, and at least one of driving, braking and/or steering of the vehicle 1 is controlled according to surrounding environment information of the vehicle 1, or in a state in which the driver is obliged to monitor the surroundings, and at least one of driving and/or braking of the vehicle 1, and steering are controlled according to the surrounding environment information of the vehicle 1, or in a state in which the driver is not obliged to monitor the surroundings, and all of driving, braking and steering of the vehicle 1 are controlled according to the surrounding environment information of the vehicle 1. Further, the automated driving control may be capable of transitioning to these respective control stages. Further, sensors that detect state information of the driver (biological information such as a heart rate, state information on facial expression and pupils) are provided, and automated driving control may be executed or suppressed according to detection results of the sensors.

<Summary of Embodiment>

### <Configuration 1>

A control device that performs travel control of a vehicle (1), the control device comprising:

a sensor (41 to 43) that detects a situation around the vehicle; and

a travel control unit (20) that performs travel control for automated driving based on a detection result of the sensor, wherein

during execution of stop transition control of decelerating or stopping the vehicle, the travel control unit
causes the vehicle to stay on a traveling road (302) when the detection result of the sensor or a state of the vehicle satisfies a predetermined condition, and
moves the vehicle to an off-road area (301) adjacent to the traveling road when the detection result of the sensor or the state of the vehicle does not satisfy the predetermined condition.

According to the configuration, a favorable position of the vehicle at the time of decelerating or stopping the vehicle can be determined. Specifically, when there is an obstacle in the off-road area, or when control performance of the vehicle is degraded, the vehicle is caused to stay on the traveling road, and thereby a risk caused by moving the vehicle to the off-road area is reduced.

### <Configuration 2>

The control device according to configuration 1, wherein

the predetermined condition includes at least one of facts

that the off-road area adjacent to the traveling road cannot be detected,

that presence of an obstacle in the off-road area adjacent to the traveling road is detected, and/or

that control performance of the vehicle is degraded.

According to the configuration, it becomes possible to properly determine a favorable position of the vehicle at the time of decelerating or stopping the vehicle.

### <Configuration 3>

The control device according to configuration 1 or 2, wherein

the travel control unit performs stop holding control after stopping the vehicle.

According to the configuration, a burden on the actuator and the like can be reduced.

### <Configuration 4>

The control device according to any one of configurations 1 to 3, wherein

the travel control unit performs deceleration control depending on presence or absence of a following vehicle in the stop transition control.

According to the configuration, it is possible to perform appropriate deceleration while considering the following vehicles.

### <Configuration 5>

The control device according to any one of configurations 1 to 4, wherein the travel control unit starts the stop transition control after performing driving handover notification to a driver of the vehicle.

According to the configuration, it is possible to start stop transition control after confirming presence or absence of a response of the driver.

### <Configuration 6>

The control device according to any one of configurations 1 to 5, wherein

when the travel control unit stops the vehicle on the traveling road in the stop transition control, the travel control unit
stops the vehicle in a position deviated from a center of a lane of the traveling road when control performance of the vehicle is not degraded, and
stops the vehicle in the center of the lane of the traveling road when control performance of the vehicle is degraded.

According to the configuration, it is possible to stop the vehicle in an appropriate position while considering a following vehicle.

### <Configuration 7>

A vehicle, including

the control device according to any one of configurations 1 to 6, and

an actuator group controlled by the travel control unit of the control device.

According to the configuration, a vehicle that decelerates or stops in a favorable position can be provided.

### <Configuration 8>

A control method of a vehicle (1) including a sensor (41 to 43) that detects a situation around the vehicle, and performing travel control for automated driving based on a detection result of the sensor, the method comprising:

during execution of stop transition control of decelerating or stopping the vehicle,
causing the vehicle to stay on a traveling road (302) when the detection result of the sensor or a state of the vehicle satisfies a predetermined condition, and
moving the vehicle to an off-road area (301) adjacent to the traveling road when the detection result of the sensor or the state of the vehicle does not satisfy the predetermined condition.

According to the configuration, it is possible to determine a favorable position of the vehicle at the time of decelerating or stopping the vehicle. Specifically, by causing the vehicle to stay on the traveling road when there is an obstacle in the off-road area or when the control performance of the vehicle is degraded, a risk cause by moving the vehicle to the off-road area is reduced.

The present invention is not limited to the above embodiments and various changes and modifications can be made within the spirit and scope of the present invention. Therefore, to apprise the public of the scope of the present invention, the following claims are made.

What is claimed is:

1. A control device that performs travel control of a vehicle, the control device comprising:
a sensor that detects a situation around the vehicle; and
a travel control unit that performs travel control for automated driving based on a detection result of the sensor, wherein
during execution of stop transition control of decelerating or stopping the vehicle, the travel control unit
causes the vehicle to stay on a traveling road when the detection result of the sensor or a state of the vehicle satisfies a predetermined condition, and
moves the vehicle to an off-road area adjacent to the traveling road when the detection result of the sensor or the state of the vehicle does not satisfy the predetermined condition.

2. The control device according to claim 1, wherein
the predetermined condition includes at least one of facts
that the off-road area adjacent to the traveling road cannot be detected,
that presence of an obstacle in the off-road area adjacent to the traveling road is detected, and/or
that control performance of the vehicle is degraded.

3. The control device according to claim 1, wherein
the travel control unit performs stop holding control after stopping the vehicle.

4. The control device according to claim 1, wherein
the travel control unit performs deceleration control depending on presence or absence of a following vehicle in the stop transition control.

5. The control device according to claim 1, wherein the travel control unit starts the stop transition control after performing driving handover notification to a driver of the vehicle.

6. The control device according to claim 1, wherein
when the travel control unit stops the vehicle on the traveling road in the stop transition control, the travel control unit
stops the vehicle in a position deviated from a center of a lane of the traveling road when control performance of the vehicle is not degraded, and
stops the vehicle in the center of the lane of the traveling road when control performance of the vehicle is degraded.

7. A vehicle, comprising:
the control device according to claim 1, and
an actuator group controlled by the travel control unit of the control device.

8. A control method of a vehicle including a sensor that detects a situation around the vehicle, and performing travel control for automated driving based on a detection result of the sensor, the method comprising:
during execution of stop transition control of decelerating or stopping the vehicle,
causing the vehicle to stay on a traveling road when the detection result of the sensor or a state of the vehicle satisfies a predetermined condition, and
moving the vehicle to an off-road area adjacent to the traveling road when the detection result of the sensor or the state of the vehicle does not satisfy the predetermined condition.
